(19) United States
(12) Patent Application Publication
(10) Pub. No.: US 2009/0024597 A1
(43) Pub. Date: Jan. 22, 2009

(54) Forming web search queries from browsing annotated images

(75) Inventor: Tomasz Imielinski, Princeton, NJ (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: IAC Search & Media, Inc.

(21) Appl. No.: 12/082,838

(22) Filed: Apr. 14, 2008

Related U.S. Application Data
(60) Provisional application No. 60/923,289, filed on Apr. 13, 2007.

(51) Int. Cl. G06F 17/30

(52) U.S. Cl. 707/4; 707/6; 707/E17.014; 707/E17.136

(57) ABSTRACT

Systems and methods for annotating images with search queries are described. Systems and methods for forming search queries by browsing annotated images are also described.

### PRIORITY

This application claims the benefit of U.S. Provisional Application No. 60/923,289, filed Apr. 13, 2007, entitled “FORMING WEB SEARCH QUERIES FROM BROWSING ANNOTATED IMAGES,” which is hereby incorporated by reference.

### FIELD

This invention relates to the field of search engines and, in particular, to systems and methods for searching using images.

### BACKGROUND

The Internet is a global network of computer systems and websites. These computer systems include a variety of documents, files, databases, and the like, which include information covering a variety of topics. It can be difficult for users of the Internet to locate this information on the Internet.

Search engines are used by most people to locate this information on the Internet. The user enters a query in text and a search engine locates search results based on the textual query.

### SUMMARY

The invention provides a computer-implemented method that includes receiving a user input indicative of a search, the user input being a selection of a region of an image; converting the selection of the image into a search query; performing a search with the search query; providing one or more responses to the user in response to the search query.

The user input may be a mouse click, a selection of a predefined region of the image, a selection of a user-defined region of the image and the like. The selection of the user-defined region of the image may include receiving a user input that includes the user highlighting a section of the image.

The selection of the image may be converted into the search query by identifying a database associated with the image, and identifying a search query in the database corresponding to the selection region of the image.

The selection of the image may be converted into the search query by identifying a plurality of search terms associated with the selected region, providing a request to the user to select one of the plurality of search terms associated with the selected region, and receiving a user input indicative of a selection of one of the plurality of search terms to be used as the search query.

The request to the user to select one of the plurality of search terms associated with the selected region may include providing a request to the user to select one of the plurality of search terms associated with the selected region or enter a user-defined search term associated with the selected region.

The invention also provides a computer-implemented method that includes dividing an image into a plurality of selectable regions; associating a search term with each of the selectable regions; storing the selectable region with the search term in a searchable database.

The method may also include associating a plurality of search terms with each of the selectable regions.

The method may also include associating a search result with the search term.

The method may also include associating a plurality of search results with the search term.

The method may also include storing the search result with the search term in the searchable database.

The method may also include storing a link to a second searchable database in the searchable database, the second searchable database comprising the search term and the search result.

The invention also provides a search system that includes a memory for storing a set of instructions; a processor connected to the memory; a data store with a plurality of search results stored in the memory; an image stored in the memory; a set of regions associated with the image stored in the memory; a transmission module stored in the memory and executable by the processor to transmit the image and the associated set of regions to a remote computer system; a receiving module to receive a selection of one of the regions from the remote computer system; and an extraction module stored in the memory and executable by the processor, the extraction module utilizing the selection to extract at least one of the search results from the data store, the search result being transmitted to the remote computer system by the transmission module.

### BRIEF DESCRIPTION OF THE DRAWINGS

The invention is described by way of example with reference to the accompanying drawings, wherein:

FIG. 1 is a block diagram illustrating a search system;

FIGS. 2A and 2B are schematic views of exemplary user interfaces;

FIG. 3 is a schematic view of a database with searches for human body parts;

FIG. 4 is a schematic view of an exemplary user interface;

FIG. 5 is a schematic view illustrating image browsing to identify search queries;

FIG. 6 is a schematic view illustrating search results associated with a search query from an image;

FIG. 7 is a schematic view of a map for use with image browsing;

FIG. 8 is a schematic view of a map that is highlighted by a user;

FIG. 9 is a schematic view of search results associated with the user selection of FIG. 8;

FIG. 10 is a flowchart of a method for tagging images;

FIG. 11 is a flowchart of a method for searching with tagged images;

FIG. 12 is a flowchart of a method for searching with tagged images;

FIGS. 13A and 13B are schematic views of an interaction between a remote computer and the search system; and

FIG. 14 is a block diagram of an exemplary computer system.

### DETAILED DESCRIPTION

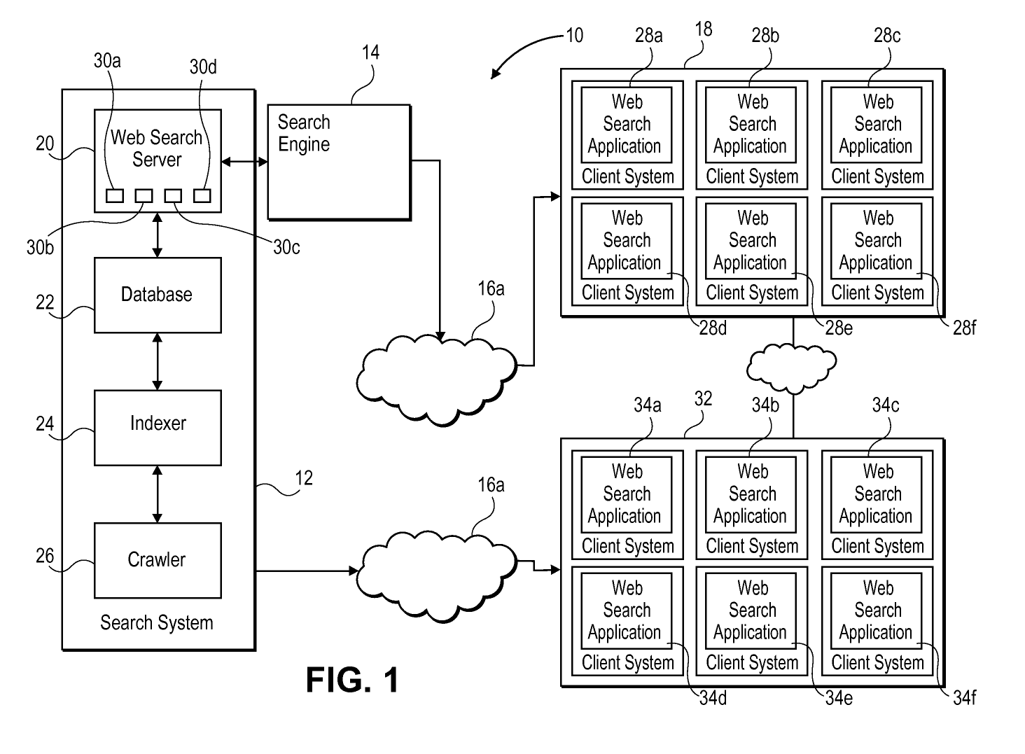

FIG. 1 of the accompanying drawings shows a network system 10 which can be used in accordance with one embodiment of the present invention. The network system 10 includes a search system 12, a search engine 14, a network 16 in the form of the Internet, a wide area protocol (WAP), etc., and a plurality of client systems 18 and a plurality of provider systems 32. The search system 12 includes a server 20, a database 22, an indexer 24, and a crawler 26. The plurality of client systems 18 includes a plurality of web search applications 28a-f, located on each of the plurality of client systems 18. The server 20 includes a plurality of databases 30a-d. The plurality of provider systems 32 includes a plurality of web sites, located on each of the provider systems 32.

The search system 12 is connected to the search engine 14. The search engine 14 is connected to the plurality of client systems 18 and provider systems 32 via the network 16. The server 20 is in communication with the database 22 which is in communication with the indexer 24. The indexer 24 is in communication with the crawler 26. The crawler 26 is capable of communicating with the plurality of target client systems 18 via the network 16.

The web search server 20 is typically a computer system, and may be an HTTP (Hypertext Transfer Protocol) server. It is envisioned that the search engine 14 may be located at the web search server 20. The web search server 20 typically includes at least processing logic and memory.

The indexer 24 is typically a software program which is used to create an index, which is then stored in storage media. The index is typically a table of alphanumeric terms with a corresponding list of the related documents or the location of the related documents (e.g., a pointer). An exemplary pointer is a Uniform Resource Locator (URL). The indexer 24 may build a hash table, in which a numerical value is attached to each of the terms. The database 22 is stored in a storage media, which typically includes the documents which are indexed by the indexer 24. The index may be included in the same storage media as the database 22 or in a different storage media. The storage media may be volatile or non-volatile memory that includes, for example, read only memory (ROM), random access memory (RAM), magnetic disk storage media, optical storage media, flash memory devices and zip drives.

The crawler 26 is a software program or software robot, which is typically used to build lists of the information found on Web sites. Another common term for the crawler 26 is a spider. The crawler 26 typically searches Web sites on the Internet and keeps track of the information located in its search and the location of the information.

The network 16 (16a, 16b, 16c, collectively) is a local area network (LAN), wide area network (WAN), a telephone network, such as the Public Switched Telephone Network (PSTN), an intranet, the Internet, or combinations thereof.

The plurality of client systems and provider systems 18, 32 may be mainframes, minicomputers, personal computers, laptops, personal digital assistants (PDA), cell phones, and the like. The plurality of client systems 18 and provider systems 32 are characterized in that they are capable of being connected to the network 16. The web search application 28a-f is typically an Internet browser or other software. Web sites may be located on the provider systems 32.

The databases 30a-d are stored in storage media located at the server 20, which include structured data, as will be discussed hereinafter. The storage media may be volatile or non-volatile memory that includes, for example, read only memory (ROM), random access memory (RAM), magnetic disk storage media, optical storage media, flash memory devices and zip drives.

In use, the crawler 26 crawls websites, such as the websites of the plurality of provider systems 32, to locate information on the web. The crawler 26 employs software robots to build lists of the information. The crawler 26 may include one or more crawlers to search the web. The crawler 26 typically extracts the information and stores it in the database 22. The indexer 24 creates an index of the information stored in the database 22. Alternatively, if a database 22 is not used, the indexer 24 creates an index of the information and where the information is located in the Internet (typically a URL).

When a user of one of the plurality of client systems 18 enters a search on the web search application 28, the search is communicated to the search engine 14 over the network 16. For example, a signal is transmitted from one of the client systems 18, the signal having a destination address (e.g., address representing search engine), a request (e.g., search query) and a return address (e.g., address representing client system). The search engine 14 communicates the search to the server 20 at the search system 12. The search engine 14 may analyze the query before sending it to the server 20. For example, the search engine 14 may parse and extract search terms from the query. The server 20 accesses the database 22 to provide a search result, which is communicated to the user via the search engine 14 and network 16. For example, the server 20 may extract search results and transmit the search results by transmitting a signal from the search engine 14 to the client system 18. For example, the signal may include a destination address corresponding to the return address of the client system, and a web results page that includes the search results.

Alternatively or in addition to accessing the index and/or database to provide the search result, the databases 30a-d can be searched, as will be described hereinafter.

The embodiment that is described herein relates to triggering a web search with browseable images that are stored in one or more of databases 30a-30d.

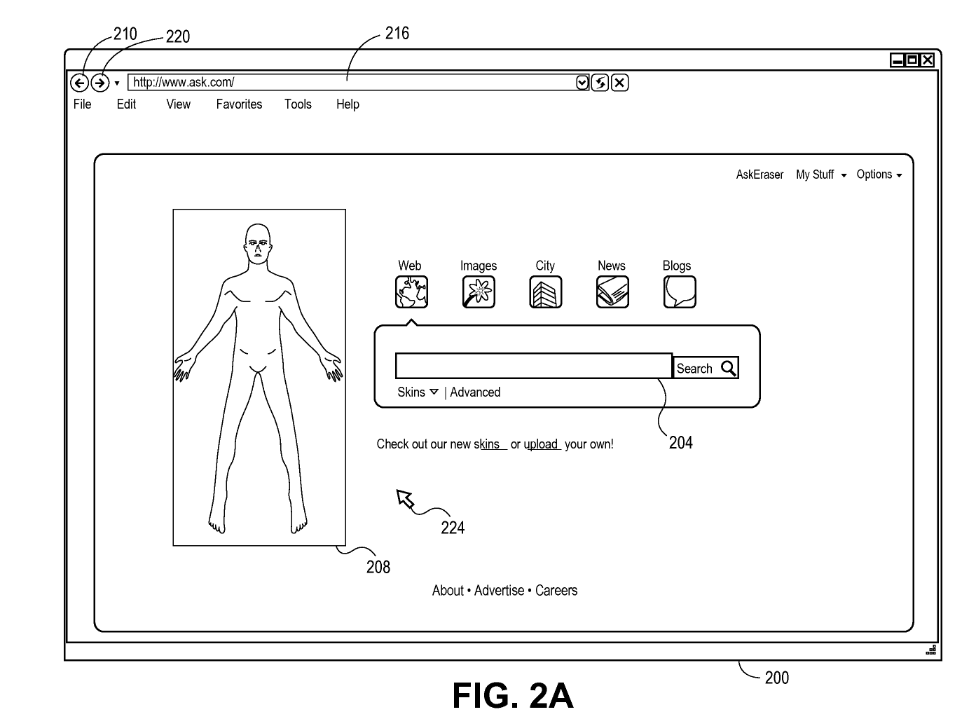

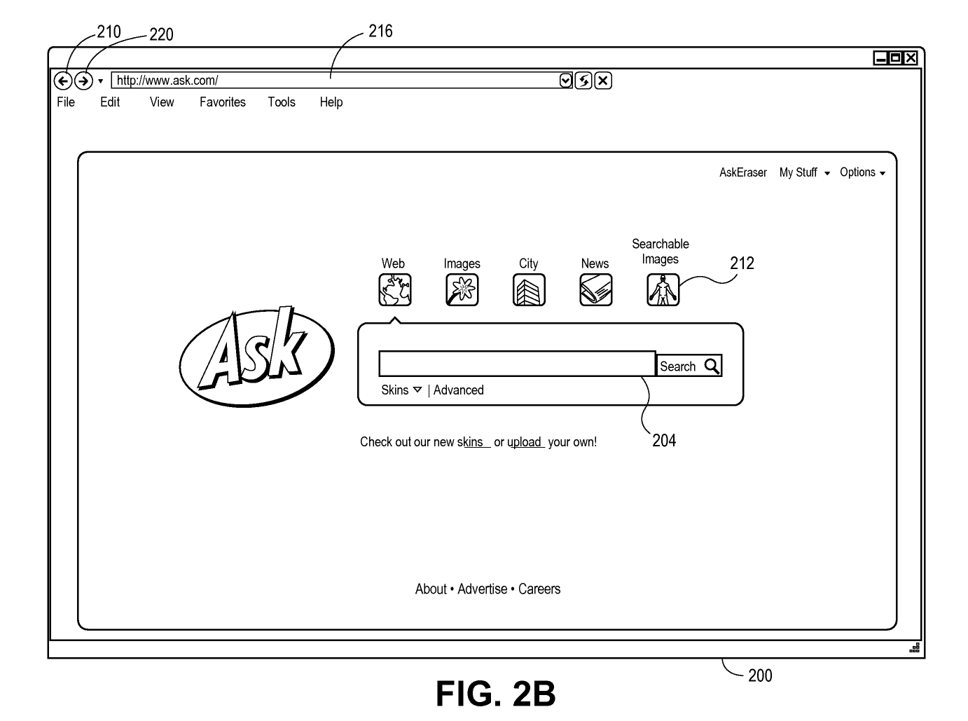

FIGS. 2A and 2B illustrate exemplary user interfaces 200a, 200b, respectively. The user interfaces 200a, 200b can be used to access the browseable images.

In FIG. 2A, the user interface 200a includes a search box 204 and an image 208. The image 208 is a browseable image. The search box 204 is configured to receive a user input, the user input being textual.

The image 208 or portions of the image 208 are configured to be selected by the user. The image 208 is annotated and/or tagged with possible search queries related to the image. The annotations and/or tags are stored in a separate database or are directly stored with the image 208 (e.g., databases 30a-d). The illustrated image 208 is a human body; it will be appreciated, however, that other images can be used.

With the user interface 200a, a user can enter a textual search query in the search box 204 or may select the image 208 or a portion of the image 208 to create a search query from the image 208.

In FIG. 2B, the user interface 200b includes a selectable icon 212. In FIG. 2B, the selectable icon 212 has the text “Searchable Images” associated with the icon 212. When a user selects the selectable icon 212, the user is presented with another user interface that has one or more browseable images that can be selected by the user to form a search query.

The user can access the user interfaces 200a, 200b, by opening an Internet browser application, such as Microsoft's Internet Explorer, and entering www.ask.com into the site address box 216. The user can navigate between pages on the website using back and forward buttons, 218, 220, as well. A cursor 224 can be used with a mouse or touchpad to navigate the cursor around the web page.

Image browsing may be a GUI action of the user. That is, the query is formed indirectly by the selection of the image. For example, the selection of the image is converted into a textual search query, which is then used to locate search results.

Alternatively, image browsing is a database query. That is, the result of browsing images is a query of search queries or results from a database associated with the image.

The image is typically editorially created. It will be appreciated that the image could alternatively come from an image feed or be located by the crawler or a separate image crawler. The image is a clickable image. That is, the image can be activated using a computer mouse. Hyperlinks may be superimposed on the image. The image is an HTML image map. Explicit pixel coordinates of rectangles and other shapes representing hot spots can be defined in HTML code. The hyperlink can be a link to a database or a textual search query. It will be appreciated that the image map can be implemented using, for example, XHTML/CSS, Javascript, Java, etc. as an alternative to HTML. The image can give an indication of hotspots (e.g., users can see the image divided into the regions) or there can be a rollover effect (as the user hovers over the image, the region is highlighted or text and/or images are displayed over the image).

As an alternative, when the user clicks on the image, the screen coordinates are sent to the server. Mouse coordinates, expressed as screen pixel values relative to the image may be communicated to the server. The mouse coordinates can be converted be converted into the textual search query or a link to the database.

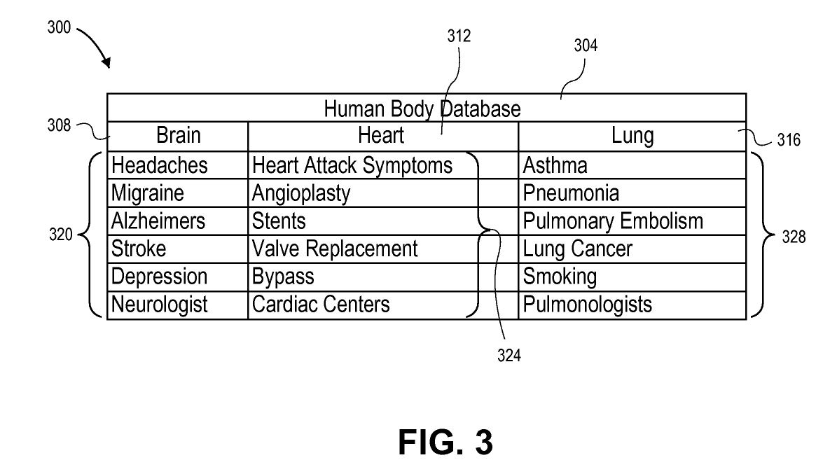

FIG. 3 is an exemplary database 300 associated with a selectable image, such as the image of the human body shown in FIG. 2A. It will be appreciated that the database will vary for different images and the database may vary from the database illustrated for an image of the human body. The database 300 may be linked to the browseable image in a number of ways. For example, the browseable image may have a pointer or link to the database associated therewith.

The database 300 is manually created. That is, an editor analyzes a clickable image or image map, and defines a set of search queries or a textual query corresponding to the clickable image or image map.

In FIG. 3, the database 300 includes a heading 304, sub-headings 308, 312 and 316, and search queries 320, 324 and 328. The heading 304 identifies the image with which the database is associated. For example, the database 300 is associated with a human body image because the heading 304 is “Human Body Database.” It will be appreciated that the heading 304 is not required and that the database can simply be associated with the image without the heading.

The sub-headings 308-316 identify selectable portions of the image. The illustrated sub-headings 308-316 are brain 308, heart 312 and lung 316. It will be appreciated that the number of sub-headings in a database depends on the number of selectable regions of the image.

Each of the sub-headings 308-316 is associated with search queries 320-328, respectively. For example, the sub-heading brain 308 is associated with the search queries 320 that include, for example, headaches, migraine, Alzheimer's, stroke, depression and neurologist. In another example, the sub-heading heart 312 is associated with the search queries 324 that include, for example, heart attack symptoms, angioplasty, stents, valve replacement, bypass and cardiac centers. In another example, the sub-heading lung 316 is associated with the search queries 328 that include, for example, asthma, pneumonia, pulmonary embolism, lung cancer, smoking and pulmonologists. It will be appreciated that the actual search queries and number of search queries associated with each sub-heading may vary from that illustrated in FIG. 3.

Although the database is illustrated in FIG. 3, it will be appreciated that the search need not go through the database of FIG. 3. Instead, the image may be directly annotated.

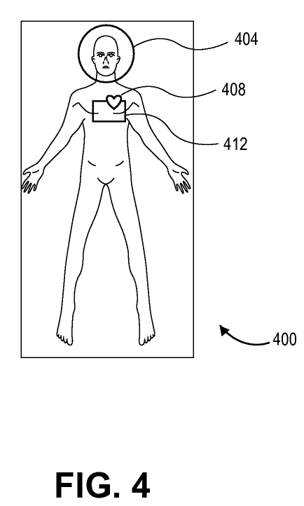

In FIG. 4, the image 400 is divided into three selectable regions: brain 404, heart 408 and lungs 412. The image 400 is associated with, for example, the database 300. Each of the sub-headings, brain 308, heart 312, lungs 316, of the database 300 of FIG. 3 corresponds with the brain 404, heart 408 and lungs 412, respectively, of the image 400 of FIG. 4. It will be appreciated that the actual number of selectable regions and type of selectable regions may vary from that illustrated. For example, the selectable regions may be fewer than three or greater than three. In another example, the selectable regions may be cardiovascular region, muscles, skin, neurology, respiratory issues, etc.

Thus, in FIGS. 3 and 4, the map of the human body may be annotated and/or tagged by a function which maps coordinates inside the body to a position on an organ or another body part. The user browses the images and selects the organ or body part.

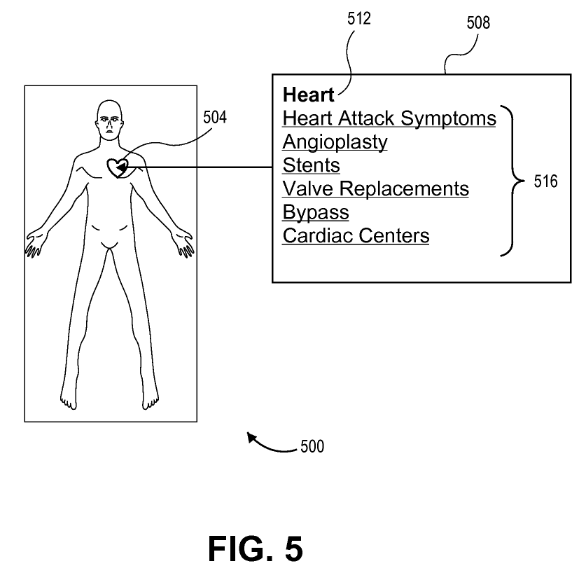

The user selection of the region of the image causes possible search queries associated with the selection (see, for example, FIG. 5) or web results associated with the selection, or both, to be provided to the user. These search queries and/or web results may be stored in a database, such as the database of FIG. 3 or directly annotated to the image.

FIG. 5 illustrates forming web search queries by browsing an annotated image in accordance with one embodiment of the invention. In FIG. 5, the image 500 includes a selectable region 504 associated with the heart. When a user selects the region 504 associated with the heart, a dialog box 508 appears.

The dialog box 508 includes an identification of the region 508 and suggested search results 512. For example, the identification of the region 508 is “heart” and the suggested search results 512 include: heart attack symptoms, angioplasty, stents, valve replacement, bypass and cardiac centers. The possible search queries may come from the database of FIG. 3, for example, or may be directly annotated to the image. The user can then select the search term from the search results 512 that best suits their interests. When the user selects one of the search terms from the search results 512, a web search is formed using the selected search term.

In one embodiment, when the user selects a part of an image, a web search is automatically performed using the body part, for example, as a search term. Other search terms related to the body part may also be used or may be suggested to the user. The search results returned may include all relevant search results. The search results may be clustered by topic (e.g., heart attack symptoms, angioplasty, stents, valve replacement, bypass and cardiac centers, etc.). If the search results are clustered by topic, users can select a topic to access more web results using the selected topic.

In another embodiment, search results are presented directly to the user. The search results can be presented in a similar manner as discussed above. For example, the search results may be clustered by topic.

The user selects a portion of the image by, for example, mouse-clicking a region of the image, mouse-ing over a region of the image, outlining a portion of the image, drawing a shape around a desired area of the image, and the like.

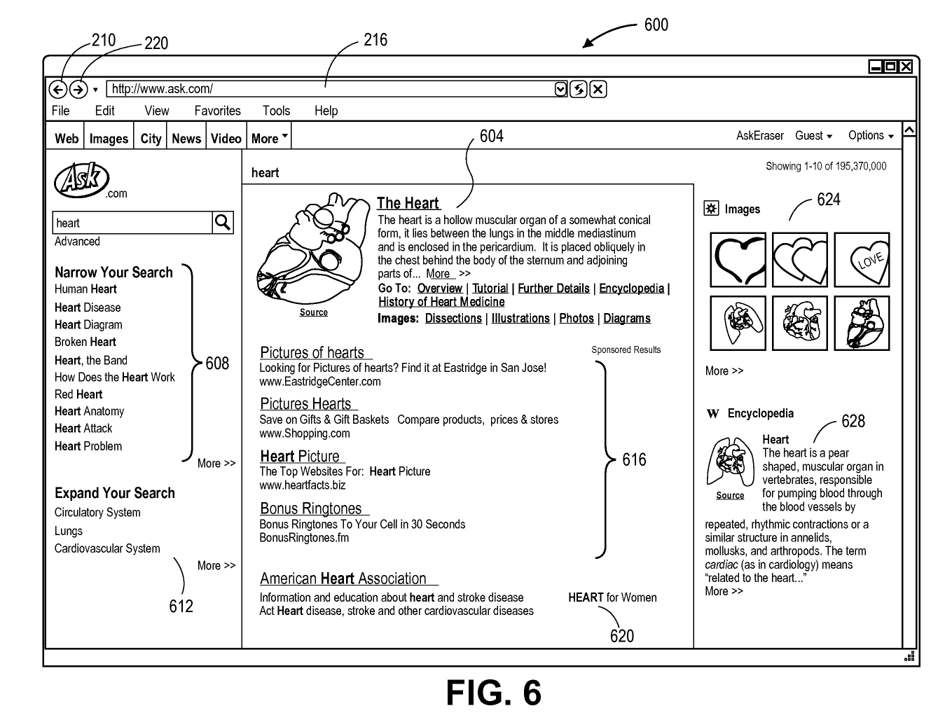

FIG. 6 illustrates a search results page 600 in accordance with one embodiment of the invention. The search results page 600 is presented to the user after selection of the selectable region (e.g., heart) of the image (e.g., body map) or after user selection of a search query presented to the user in response to a selection of the selectable region of the image.

In FIG. 6, the results page 600 includes a description of the heart 604, narrow suggested search queries 608, broad suggested search queries 612, sponsored results 616, search results 620, images 624 and an encyclopedia entry 628.

In one embodiment, if a user is browsing web results from a textual search related to health and mouses-over a word in the document, the body map may be automatically available and the body part may be highlighted. It will be appreciated that users browsing web results for other topics may be presented with other types of browseable images. For example, if a user is browsing web results for a city, a browseable map of San Diego may be presented to the user.

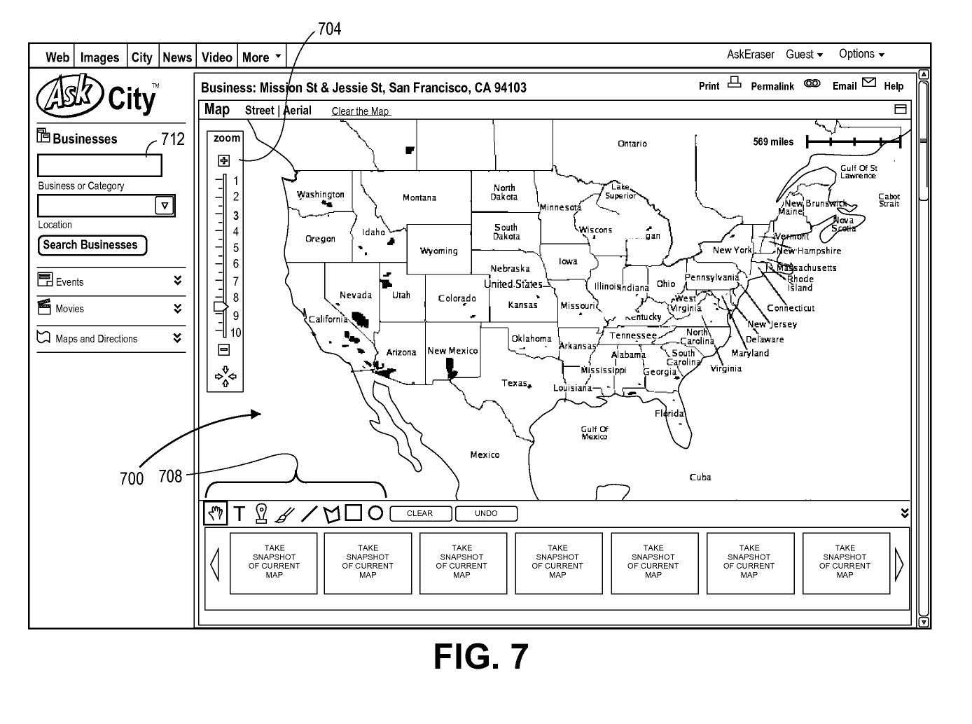

FIG. 7 illustrates a map 700 that includes a zoom feature 704 and a toolbar 708. The toolbar 708 includes user selectable buttons that allow a user to manipulate the map and draw shapes on the map 700. The map 700 also has a text box 712 in which types of businesses can be entered.

The map 700 may have a location database tagged thereto. The location database may include, for example, global positioning coordinates and business names, road names, cities and the like.

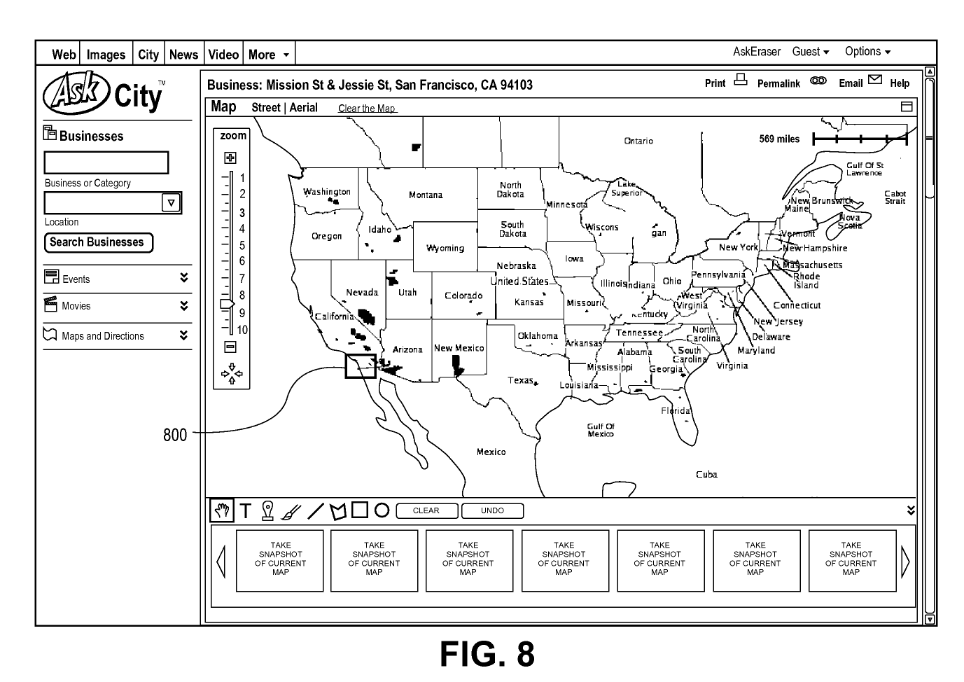

As shown in FIG. 8, a user can highlight an area of the map 700 with a box 800. The position or region of the map highlighted by the box 800 is tagged into a query. In one embodiment a list of cities within the highlighted area or other relevant information, such as major attractions, destinations and the like, is provided to the user. The user then selects one of the presented results to perform a web search. In another embodiment, web results about that location (e.g., city, highway, building) are returned to the user directly.

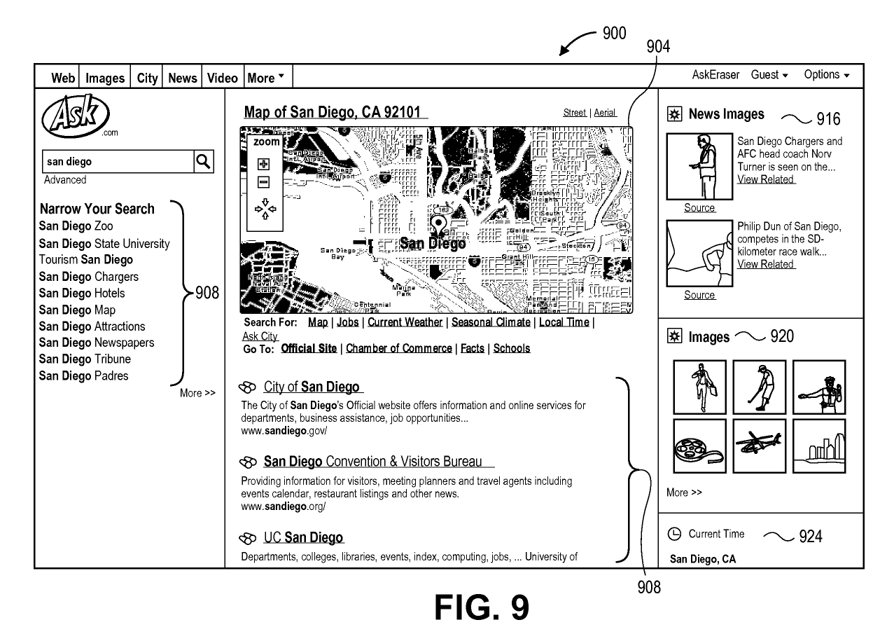

For example, in FIG. 8, the box 800 is drawn around San Diego, Calif. Search results relating to San Diego, Calif. are returned to the user as shown in FIG. 9.

In FIG. 9, the search results page 900 includes several regions including a detailed map 904, narrow search suggestions 908, search results 912, news images 916, images 920 and the current time 924. It will be appreciated that the results page 900 may vary from that illustrated and include a fewer or greater number of regions.

It will be appreciated that in FIG. 8, a user could highlight a region with a box 800 and also enter a text search into the text box 712 to get more focused search results. For example, the user could enter restaurants in the text box 712 and highlight San Diego with the box 800 to create a search for restaurants in San Diego. Search results relating to restaurants in San Diego would be presented to the user. The search results could be clustered by, for example, location in San Diego (e.g., Gaslamp district, hotel circle, La Jolla, etc.) or type of cuisine (e.g., Mexican, Thai, Californian, fine dining, etc.).

In another example, photos may be annotated. For example, people in a photo may be tagged by their names. By selecting a person in the photo by, for example, dragging a mouse pointer over the person, web search results for the selected person may be presented to the user.

In another example, product images can be annotated. A pointer action over the product would automatically return search results related to the product. For example, an image of a digital camera can be annotated with various features of the digital camera, such as where to buy the digital camera, manufacturers of the digital camera, technical descriptions of the digital camera, and the like.

It will be appreciated that any of the browseable images described herein (e.g., body map, city map, other images, photos, product images, etc.) may be 2D (two-dimensional) or 3D (three-dimensional). The browseable images may be manipulatable by the user (e.g., zoom, rotate, pan, etc.).

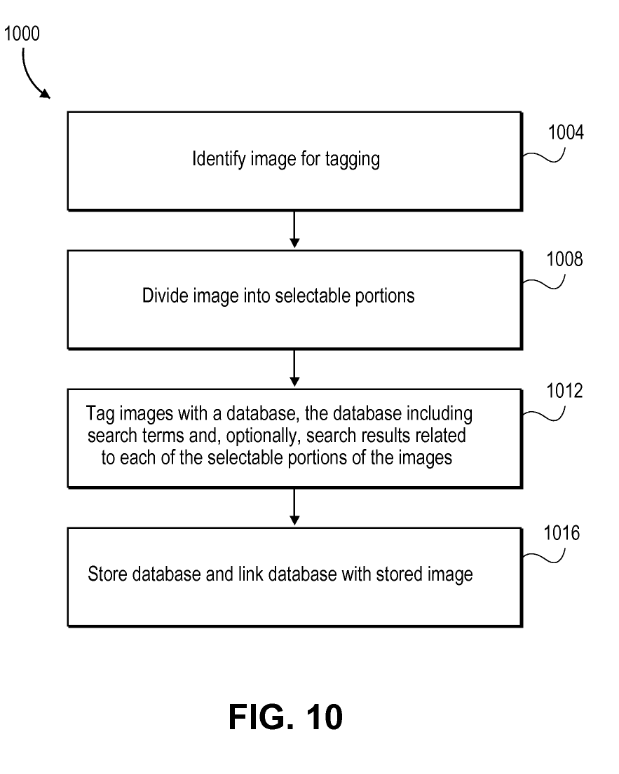

FIG. 10 illustrates a method 1000 for annotating images in accordance with one embodiment of the invention. The method 1000 begins by identifying an image for tagging (block 1004). The method 1000 continues by dividing the image into selectable portions (block 1008). The method 1000 continues by tagging images with a database (block 1012). Annotating databases is disclosed in further detail in U.S. patent application Ser. No. 11/233,745, the entirety of which is hereby incorporated by reference. The database may include search terms and optionally search results related to each of the selectable portions of the image. The method 1000 continues by storing the database and linking the database with the image (block 1016).

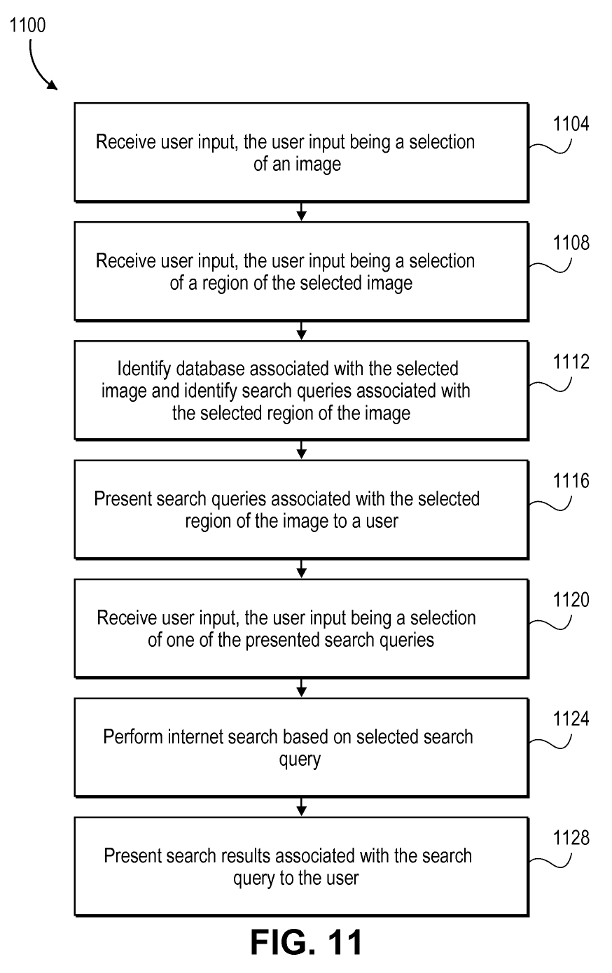

FIG. 11 illustrates a method 1100 of searching with annotated images in accordance with one embodiment of the invention. The method 1100 begins by receiving user input, the user input being a selection of an image (block 1104). The method 1100 continues by receiving user input, the user input being a selection of a region of the selected image (block 1108). The method 1100 continues by identifying a database associated with the selected image and identifying search queries associated with the selection region of the image (block 1112). The method 1100 continues by presenting search queries associated with the selected region of the image to a user (block 1116). The method 1100 continues by receiving user input, the user input being a selection of one of the presented search queries (block 1120). The method 1100 continues by performing an internet search based on the selected search query (block 1124). The method 1100 continues by presenting search results associated with the search query to the user (block 1128).

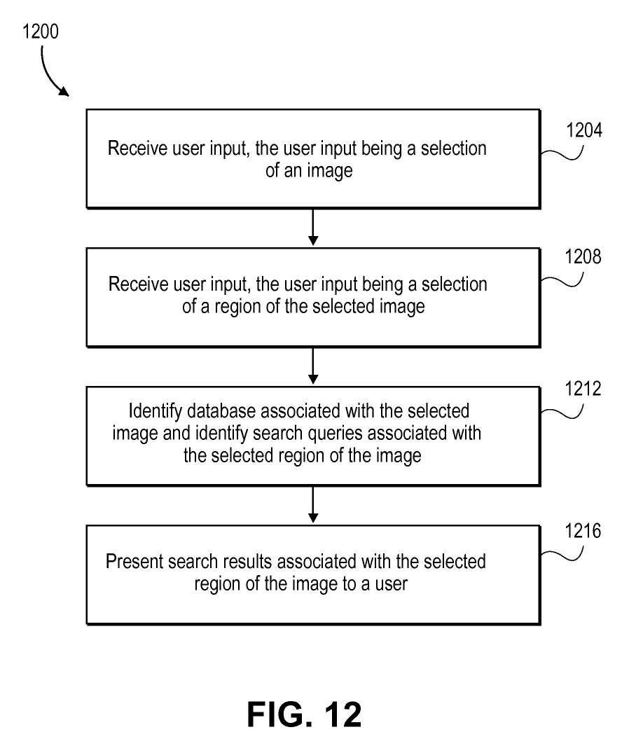

FIG. 12 illustrates a method 1200 of searching with annotated images in accordance with another embodiment of the invention. The method 1200 beings by receiving user input; the user input being a selection of an image (block 1204). The method 1200 continues by receiving user input, the user input being a selection of a region of the selected image (block 1208). The method 1200 continues by identifying a database associated with the selected image and identifying search queries associated with the selected region of the image (block 1212). The method 1200 continues by presenting search results associated with the selected region of the image to a user (block 1216).

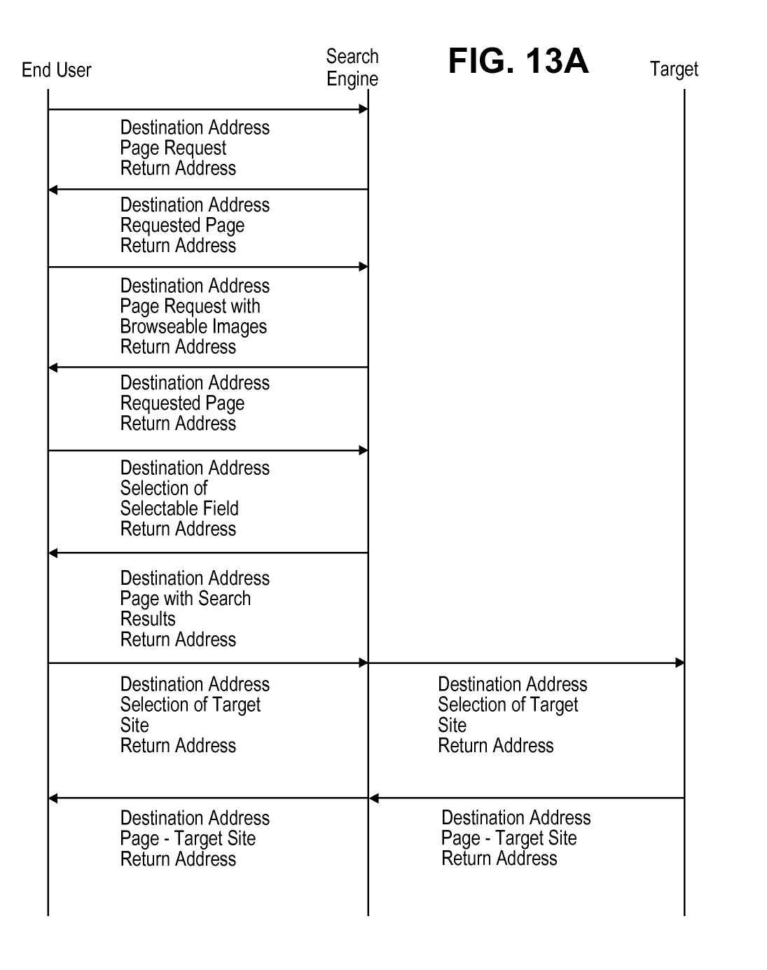

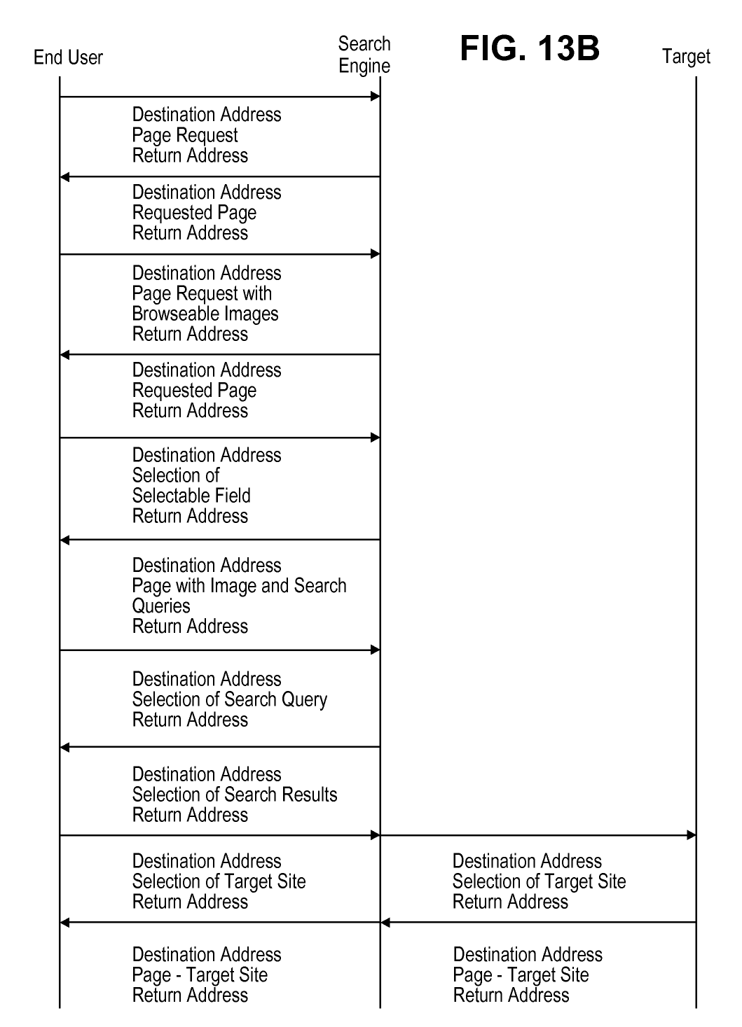

FIGS. 13A and 13B illustrate interaction between the user via the remote computer and the search engine provider via the search system. FIG. 13A illustrates an embodiment in which the search results are provided directly to the user while FIG. 13B illustrates an embodiment in which the user selects a search query after selecting a region of the image to get search results.

In FIG. 13A, the method begins with the user sending a signal from the remote computer to the search engine. The signal includes information of the destination address, a page request and a return address. The search engine returns a signal that includes the requested page to the return address. The requested page is, for example, the user interface of FIG. 2B. The user sends another signal from the remote computer to the search engine requesting a page with browseable images. For example, the user selects the browseable image icon in the user interface of FIG. 2B. In response, the search engine returns the page with the browseable images to the remote computer in the form of a signal.

The user sends another signal from the remote computer to the search engine, the signal being a selection of a field or region in the browseable image. The search engine responds to the signal by returning a page of search results to the user at the return address of the remote computer.

The user sends a signal to the search engine selecting a target site from the search results. The search engine sends a request to the target site requesting a page from the target site. The target site then returns the page of the target to the address of the search engine, which sends the page of the target to the address of the remote computer.

In FIG. 13B, the method begins with the user sending a signal from the remote computer to the search engine. The signal includes information of the destination address, a page request and a return address. The search engine returns a signal that includes the requested page to the return address. The requested page is, for example, the user interface of FIG. 2B. The user sends another signal from the remote computer to the search engine requesting a page with browseable images. For example, the user selects the browseable image icon in the user interface of FIG. 2B. In response, the search engine returns the page with the browseable images to the remote computer in the form of a signal.

The user sends another signal from the remote computer to the search engine, the signal being a selection of a field or region in the browseable image. The search engine responds to the signal by returning a page with the image and search queries.

The user sends a signal to the search engine including a selection of the search query. The search engine returns a results page corresponding to the selected search query.

The user sends a signal to the search engine selecting a target site from the search results. The search engine sends a request to the target site requesting a page from the target site. The target site then returns the page of the target to the address of the search engine, which sends the page of the target to the address of the remote computer.

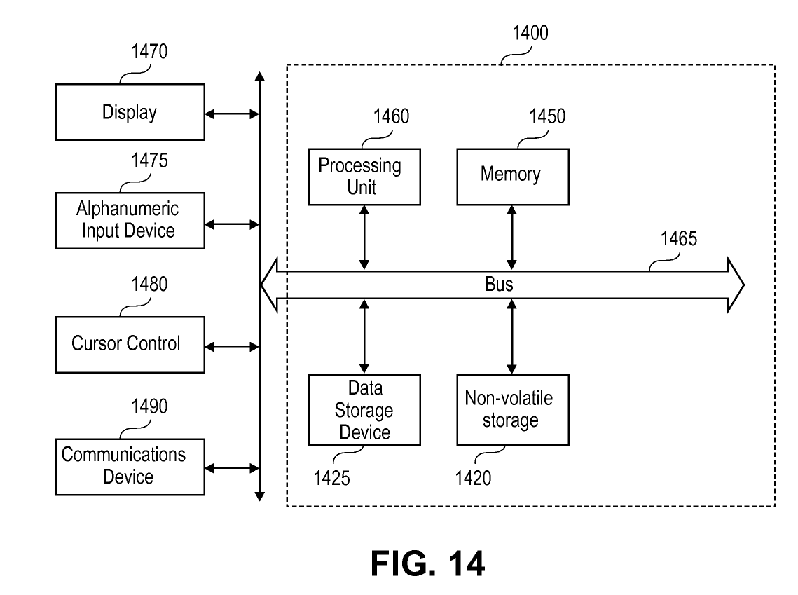

FIG. 14 is one embodiment of a computer system on which embodiments of the present invention may be implemented. It will be apparent to those of ordinary skill in the art, however, that other alternative systems of various system architectures may also be used.

The data processing system illustrated in FIG. 14 includes a bus or other internal communication means 1465 for communicating information, and a processor 1460 coupled to the bus 1465 for processing information. The system further comprises a random access memory (RAM) or other volatile storage device 1450 (referred to as memory), coupled to bus 1465 for storing information and instructions to be executed by processor 1460. Main memory 1450 also may be used for storing temporary variables or other intermediate information during execution of instructions by processor 1460. The system also comprises a read only memory (ROM) and/or static storage device 1420 coupled to bus 1465 for storing static information and instructions for processor 1460, and a data storage device 1425 such as a magnetic disk or optical disk and its corresponding disk drive. Data storage device 1425 is coupled to bus 1465 for storing information and instructions.

The system may further be coupled to a display device 1470, such as a cathode ray tube (CRT) or a liquid crystal display (LCD) coupled to bus 1465 through bus 1465 for displaying information to a computer user. An alphanumeric input device 1475, including alphanumeric and other keys, may also be coupled to bus 1465 through bus 1465 for communicating information and command selections to processor 1460. An additional user input device is cursor control device 1480, such as a mouse, a trackball, stylus, or cursor direction keys coupled to bus 1465 through bus 1465 for communicating direction information and command selections to processor 1460, and for controlling cursor movement on display device 1470.

Another device, which may optionally be coupled to computer system 1400, is a communication device 1490 for accessing other nodes of a distributed system via a network. The communication device 1490 may include any of a number of commercially available networking peripheral devices such as those used for coupling to an Ethernet, token ring, Internet, or wide area network. The communication device 1490 may further be a null-modem connection, or any other mechanism that provides connectivity between the computer system 1400 and the outside world. Note that any or all of the components of this system illustrated in FIG. 14 and associated hardware may be used in various embodiments of the present invention.

It will be appreciated by those of ordinary skill in the art that any configuration of the system may be used for various purposes according to the particular implementation. The control logic or software implementing the present invention can be stored in main memory 1450, mass storage device 1425, or other storage medium locally or remotely accessible to processor 1460.

It will be apparent to those of ordinary skill in the art that the system, method, and process described herein can be implemented as software stored in main memory 1450 or read only memory 1420 and executed by processor 1460. This control logic or software may also be resident on an article of manufacture comprising a computer readable medium having computer readable program code embodied therein and being readable by the mass storage device 1425 and for causing the processor 1460 to operate in accordance with the methods and teachings herein.

The present invention may also be embodied in a handheld or portable device containing a subset of the computer hardware components described above. For example, the handheld device may be configured to contain only the bus 1465, the processor 1460, and memory 1450 and/or 1425. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 1460, a data storage device 1425, a bus 1465, and memory 1450, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

It will be appreciated by those of ordinary skill in the art that any configuration of the system may be used for various purposes according to the particular implementation. The control logic or software implementing the present invention can be stored on any machine-readable medium locally or remotely accessible to processor 1460. A machine-readable medium includes any mechanism for storing or transmitting information in a form readable by a machine (e.g. a computer). For example, a machine readable medium includes read-only memory (ROM), random access memory (RAM), magnetic disk storage media, optical storage media, flash memory devices, electrical, optical, acoustical or other forms of propagated signals (e.g. infrared signals, digital signals, etc.).

The foregoing description with attached drawings is only illustrative of possible embodiments of the described method and should only be construed as such. Other persons of ordinary skill in the art will realize that many other specific embodiments are possible that fall within the scope and spirit of the present idea. The scope of the invention is indicated by the following claims rather than by the foregoing description. Any and all modifications which come within the meaning and range of equivalency of the following claims are to be considered within their scope.

1. A computer-implemented method comprising:
receiving a user selection of a region of an image;
converting the selection of the image into a search query;
performing a search with the search query;
providing one or more responses to the user in response to the search query.

2. The computer-implemented method of claim 1, wherein the user selection is a mouse click.

3. The computer-implemented method of claim 1, wherein the user selection is a selection of a predefined region of the image.

4. The computer-implemented method of claim 1, wherein the user selection is a selection of a user-defined region of the image.

5. The computer-implemented method of claim 4, wherein the selection of the user-defined region of the image comprises receiving a user input that comprises the user highlighting a section of the image.

6. The computer-implemented method of claim 1, wherein converting the selection of the image into the search query comprises:
identifying a database associated with the image; and
identifying a search query in the database corresponding to the selection region of the image.

7. The computer-implemented method of claim 1, wherein converting the selection of the image into the search query comprises:
identifying a plurality of search terms associated with the selected region;
providing a request to the user to select one of the plurality of search terms associated with the selected region; and
receiving a user input indicative of a selection of one of the plurality of search terms to be used as the search query.

8. The computer-implemented method of claim 7, wherein providing a request to the user to select one of the plurality of search terms associated with the selected region comprises providing a request to the user to select one of the plurality of search terms associated with the selected region or enter a user-defined search term associated with the selected region.

9. A computer-implemented method comprising:
storing an image in a first data store, the image divided into a plurality of selectable regions;
storing a database in a second data store, the database including data structured according to each of the plurality of selectable regions and a search query corresponding to each of the plurality of selectable regions; and
linking the image with the database.

10. The computer-implemented method of claim 9, wherein the first data store and the second data store are stored together in memory.

11. The computer-implemented method of claim 9, wherein the database comprises a plurality of search queries corresponding to each of the selectable regions.

12. The computer-implemented method of claim 9, wherein the database further comprises a search result with the search query.

13. The computer-implemented method of claim 9, wherein the database further comprises a plurality of search results with the search query.

14. The computer-implemented method of claim 9, wherein linking the image with the database comprises storing a pointer to the database with the image.

15. A computer system comprising:
a memory for storing a set of instructions;
a processor connected to the memory;
a data store with a plurality of search results stored in the memory;
an image stored in the memory;
a set of regions associated with the image stored in the memory;
a transmission module stored in the memory and executable by the processor to transmit the image and the associated set of regions to a remote computer system;
a receiving module to receive a selection of one of the regions from the remote computer system; and
an extraction module stored in the memory and executable by the processor, the extraction module utilizing the selection to extract at least one of the search results from the data store, the search result being transmitted to the remote computer system by the transmission module.

16. The computer system of claim 15, wherein the memory and processor are located in a server computer system.

17. The computer system of claim 15, wherein the set of regions are stored in the memory in a database.

18. The computer system of claim 15, further comprising a set of search queries stored in the memory, the set of search queries associated with each region of the set of regions.

19. The computer system of claim 15, further comprising a set of search results stored in the memory, the set of search results associated with each region of the set of regions.

20. A computer-readable medium having stored thereon a set of instructions which when executed by a processor of a computer executes the method comprising:
receiving a user selection of a region of an image;
converting the selection of the image into a search query;
performing a search with the search query;
providing one or more responses to the user in response to the search query.

21. A computer-readable medium having stored thereon a set of instructions which when executed by a processor of a computer executes the method comprising:
storing an image in a first data store, the image divided into a plurality of selectable regions;
storing a database in a second data store, the database including data structured according to each of the plurality of selectable regions and a search query corresponding to each of the plurality of selectable regions; and
linking the image with the database.
